(19) United States
(12) Patent Application Publication
(10) Pub. No.: US 2014/0278681 A1
(43) Pub. Date: Sep. 18, 2014

(54) CONTRACTOR SCHEDULING AND COMPONENT PURCHASING SERVICE

(71) Applicant: Emerson Electric Co., St. Louis, MO (US)

(72) Inventors: Steven A. Cox, Clayton, MO (US); Paul Layton, Brentwood, MO (US)

(73) Assignee: Emerson Electric Co., St. Louis, MO (US)

(21) Appl. No.: 14/208,105

(22) Filed: Mar. 13, 2014

Related U.S. Application Data
(60) Provisional application No. 61/793,811, filed on Mar. 15, 2013.
(60) Provisional application No. 61/888,783, filed on Oct. 9, 2013.

(51) Int. Cl. G06Q 30/06; G06Q 10/10

(52) U.S. Cl. CPC G06Q 30/0641; G06Q 30/0623; G06Q 10/1095; G06Q 30/0613
USPC 705/7.19; 705/27.1; 705/26.61; 705/26.41

(57) ABSTRACT

A system and method includes a database storing faults, each fault having an indicator corresponding to whether the associated fault is designated for self-maintenance. A monitoring system is in communication with the database and monitors operating parameters of an HVAC system at a customer location, detects or predicts a fault in the HVAC system, determines whether the fault is designated for self-maintenance, and communicates an alert corresponding to the fault to a customer device. When the alert received by the customer device indicates that the fault in the HVAC system is designated for self-maintenance, the customer device displays an identification of a replacement component associated with maintenance for the fault and a first interface to receive at least one of a first selection for a contractor to deliver the replacement component and a second selection for purchasing the replacement component through a commercial retailer.

### CROSS-REFERENCE TO RELATED APPLICATIONS

This application claims the benefit of U.S. Provisional Application No. 61/793,811, filed on Mar. 15, 2013 and of U.S. Provisional Application No. 61/888,783, filed on Oct. 9, 2013. The entire disclosures of the above applications are incorporated herein by reference.

### FIELD

The present disclosure relates to a system and method for a contractor scheduling service and, more specifically, to a system and method for a contractor scheduling service for HVAC systems and other equipment.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Heating, ventilation, and air conditioning (HVAC) systems, and other equipment, such as electrical systems, lighting systems, plumbing systems, appliances, electronic equipment, and the like, periodically require maintenance and repair. When an HVAC system malfunctions or is in need of maintenance, a user of the HVAC system, for example a resident or owner of a building corresponding to the HVAC system may contact a contractor to perform the repair or maintenance. To find and select a contractor to perform the repair or maintenance, the resident or owner may ask friends and neighbors if they can recommend any particular contractor. Additionally, the resident or owner may search on the internet or review ads in a newspaper to find potential contractors that could assist.

Contractors that are found and contacted using these traditional methods, however, may or may not be available at the time the HVAC system needs maintenance or repair. Additionally, contractors that are found and contacted using these traditional methods may or may not have the requisite expertise, certifications, training, tools, and replacement parts necessary to perform the particular repair or maintenance needed for the HVAC system.

### SUMMARY

This section provides a general summary of the disclosure, and is not a comprehensive disclosure of its full scope or all of its features.

A system is provided and includes a customer device associated with an HVAC system at a customer location and a plurality of contractor devices. Each contractor device is associated with a contractor at a contractor location and stores contractor information including contractor location data corresponding to the contractor location of the associated contractor and contractor availability data corresponding to an availability of the associated contractor. A server is in communication with the customer device and the plurality of contractor devices and is configured to receive a service request for the HVAC system from the customer device, to receive the contractor information from each of the contractor devices, to apply a selection criteria to the received contractor information, to determine at least one potential contractor for the service request based on the application of the selection criteria, and to communicate the contractor information for the at least one potential contractor to the customer device. The customer device is configured to receive the contractor information for the at least one potential contractor from the server, to display the contractor information for the at least one potential contractor, to receive a selection indicating a designated contractor from the at least one potential contractor to perform the service request for the HVAC system, and to communicate the selection to the server. The server is configured to notify the contractor device for the designated contractor of the selection.

Another system is provided and includes a customer device associated with an HVAC system at a customer location and a plurality of contractor devices. Each contractor device is associated with a contractor at a contractor location. Each contractor device stores contractor information including contractor location data corresponding to the contractor location of the associated contractor and contractor availability data corresponding to an availability of the associated contractor. A server is in communication with the customer device and the plurality of contractor devices. The server is configured to receive a service request for the HVAC system from the customer device, to receive the contractor information from each of the contractor devices, to apply a selection criteria to the received contractor information, to determine at least one potential contractor for the service request based on the application of the selection criteria, to communicate the service request to the associated contractor device for the at least one potential contractor, to receive an acceptance of the service request from a designated contractor from the at least one potential contractor, and to communicate the associated contractor information for the designated contractor to the customer device. The customer device is configured to receive the contractor information for the designated contractor.

Another system is provided and includes a customer device associated with an HVAC system at a customer location and a plurality of contractor devices. Each contractor device is associated with a contractor at a contractor location. Each contractor device stores contractor information including contractor location data corresponding to the contractor location of the associated contractor and contractor availability data corresponding to an availability of the associated contractor. A monitoring system monitors operating parameters of the HVAC system, generates an alert based on the operating parameters, and communicates the alert to the customer device. A server is in communication with the monitoring system, the customer device, and the plurality of contractor devices. The server is configured to receive the alert from the monitoring system, to receive the contractor information from each of the contractor devices, to apply a selection criteria to the received contractor information, to determine at least one potential contractor for the service request based on the application of the selection criteria, and to communicate the contractor information for the at least one potential contractor to the customer device. The customer device is configured to receive the contractor information for the at least one potential contractor from the server, to display the contractor information for the at least one potential contractor, to receive a selection indicating a designated contractor from the at least one potential contractor to perform at least one of maintenance and repair of the HVAC system based on the alert, and to communicate the selection to the server. The server is configured to notify the contractor device for the designated contractor of the selection.

Another system is provided and includes a customer device associated with an HVAC system at a customer location and a plurality of contractor devices. Each contractor device is associated with a contractor at a contractor location. Each contractor device stores contractor information including contractor location data corresponding to the contractor location of the associated contractor and contractor availability data corresponding to an availability of the associated contractor. The plurality of contractor devices includes a first contractor device associated with a first contractor assigned to service the HVAC system and a second contractor device associated with a second contractor assigned to service the HVAC system in the event the first contractor is unavailable. A monitoring system monitors operating parameters of the HVAC system, generates an alert based on the operating parameters, and communicates the alert to the customer device. A server is in communication with the monitoring system, the customer device, and the plurality of contractor devices. The server is configured to receive the alert from the monitoring system, to receive the contractor information from each of the contractor devices, to determine whether the first contractor is available based on contractor information from the first contractor device, to notify the first contractor of the alert when the first contractor is determined to be available, and to notify the second contractor of the alert when the first contractor is determined to be unavailable.

Another system is provided and includes a customer device associated with an HVAC system at a customer location and a plurality of contractor devices, including a dispatcher contractor device and a plurality of field contractor devices. Each field contractor device is associated with a contractor at a contractor location. Each field contractor device stores contractor information including contractor location data corresponding to the contractor location of the associated contractor and contractor availability data corresponding to an availability of the associated contractor. A monitoring system monitors operating parameters of the HVAC system, generates an alert based on the operating parameters, and communicates the alert to the customer device. A server is in communication with the monitoring system, the customer device, and the plurality of contractor devices. The server is configured to receive the alert from the monitoring system, to receive the contractor information from each of the field contractor devices, and to communicate the alert and the contractor information to the dispatcher contractor device. The dispatcher contractor device is configured to display the contractor information and the alert, to receive a selection indicating a designated contractor to perform at least one of maintenance and repair of the HVAC system based on the alert, and to communicate the selection to the server. The server is configured to notify the field contractor device for the designated contractor of the selection.

Another system is provided and includes a customer device associated with equipment at a customer location. The system also includes a plurality of contractor devices, each contractor device being associated with a contractor at a contractor location, each contractor device storing contractor location data corresponding to the contractor location of the associated contractor. The system also includes a server in communication with the customer device and the plurality of contractor devices. The server is configured to receive a service request for the equipment from the customer device, to receive contractor information including the contractor location data from each of the contractor devices and contractor availability data corresponding to an availability of each contractor associated with the plurality of contractor devices, to apply a selection criteria to the received contractor information, to determine at least one potential contractor for the service request based on the application of the selection criteria, and to communicate the contractor information for the at least one potential contractor to the customer device. The customer device is configured to receive the contractor information for the at least one potential contractor from the server, to display the contractor information for the at least one potential contractor, to receive a selection indicating a designated contractor from the at least one potential contractor to perform the service request for the equipment, and to communicate the selection to the server. The server is configured to notify the contractor device for the designated contractor of the selection.

A method is provided and includes storing, in each of a plurality of contractor devices, contractor information for an associated contractor, including contractor location data corresponding to a contractor location of the associated contractor and contractor availability data corresponding to an availability of the associated contractor. The method also includes receiving, with a server, a service request for an HVAC system at a customer location associated with a customer device. The method also includes receiving, with the server, the contractor information from each of the contractor devices. The method also includes applying, with the server, a selection criteria to the received contractor information to determine at least one potential contractor for the service request based on the application of the selection criteria. The method also includes communicating the contractor information for the at least one potential contractor to the customer device. The method also includes receiving, with the customer device, the contractor information for the at least one potential contractor from the server. The method also includes displaying, with the customer device, the contractor information for the at least one potential contractor. The method also includes receiving, with the customer device, a selection indicating a designated contractor from the at least one potential contractor to perform the service request for the HVAC system. The method also includes communicating the selection from the customer device to the server. The method also includes notifying, with the server, the contractor device for the designated contractor of the selection.

Another method is provided and includes storing, in each of a plurality of contractor devices, contractor information for an associated contractor, including contractor location data corresponding to a contractor location of an associated contractor and contractor availability data corresponding to an availability of the associated contractor. The method also includes receiving, with a server in communication with the plurality of contractor devices, a service request for an HVAC system at a customer location associated with a customer device, the service request being received by the server from the customer device. The method also includes receiving, with the server, the contractor information from each of the contractor devices. The method also includes applying, with the server, a selection criteria to the received contractor information. The method also includes determining, with the server, at least one potential contractor for the service request based on the application of the selection criteria. The method also includes communicating the service request from the server to the associated contractor device for the at least one potential contractor. The method also includes receiving an acceptance of the service request from a designated contractor from the at least one potential contractor. The method also includes communicating the associated contractor information for the designated contractor from the server to the customer device. The method also includes receiving, with the customer device, the contractor information for the designated contractor.

Another method is provided and includes storing, in each of a plurality of contractor devices, contractor information for an associated contractor, including contractor location data corresponding to a contractor location of the associated contractor and contractor availability data corresponding to an availability of the associated contractor. The method also includes monitoring, with a monitoring system, operating parameters of an HVAC system at a customer location. The method also includes generating an alert, with the monitoring system, based on the operating parameters. The method also includes communicating, with the monitoring system, the alert to a customer device associated with the HVAC system at the customer location. The method also includes receiving, with a server, the alert from the monitoring system, the server being in communication with the monitoring system, the customer device, and the plurality of contractor devices. The method also includes receiving, with the server, the contractor information from each of the contractor devices. The method also includes applying, with the server, a selection criteria to the received contractor information. The method also includes determining, with the server, at least one potential contractor for the service request based on the application of the selection criteria. The method also includes communicating, with the server, the contractor information for the at least one potential contractor to the customer device. The method also includes receiving, with the customer device, the contractor information for the at least one potential contractor from the server. The method also includes displaying, with the customer device, the contractor information for the at least one potential contractor. The method also includes receiving, with the customer device, a selection indicating a designated contractor from the at least one potential contractor to perform at least one of maintenance and repair of the HVAC system based on the alert. The method also includes communicating the selection from the customer device to the server. The method also includes notifying, with the server, the contractor device for the designated contractor of the selection.

Another method is provided and includes storing, in each of a plurality of contractor devices, contractor information for an associated contractor, including contractor location data corresponding to the contractor location of the associated contractor and contractor availability data corresponding to an availability of the associated contractor, the plurality of contractor devices including a first contractor device associated with a first contractor assigned to service an HVAC system at a customer location and a second contractor device associated with a second contractor assigned to service the HVAC system in the event the first contractor is unavailable. The method also includes monitoring, with a monitoring system, operating parameters of the HVAC system. The method also includes generating, with the monitoring system, an alert based on the operating parameters. The method also includes communicating, with the monitoring system, the alert to the customer device. The method also includes receiving, with a server, the alert from the monitoring system, the server being in communication with the monitoring system, the plurality of contractor devices, and a customer device associated with the HVAC system. The method also includes receiving, with the server, contractor information from each of the contractor devices. The method also includes determining, with the server, whether the first contractor is available based on contractor information from the first contractor device. The method also includes notifying, with the server, the first contractor, through the first contractor device, of the alert when the first contractor is determined to be available. The method also includes notifying, with the server, the second contractor, through the second contractor device, of the alert when the first contractor is determined to be unavailable.

Another method is provided and includes storing, in each of a plurality of contractor devices, contractor information for an associated contractor, including contractor location data corresponding to a contractor location of the associated contractor and contractor availability data corresponding to an availability of the associated contractor, the plurality of contractor devices including a dispatcher contractor device and a plurality of field contractor devices. The method also includes monitoring, with a monitoring system, operating parameters of an HVAC system at a customer location. The method also includes generating, with the monitoring system, an alert based on the operating parameters. The method also includes communicating, with the monitoring system, the alert to a customer device associated with the HVAC system at the customer location. The method also includes receiving, with a server, the alert from the monitoring system, the server being in communication with the monitoring system, the customer device, and the plurality of contractor devices. The method also includes receiving, with the server, the contractor information from each of the field contractor devices. The method also includes communicating, with the server, the alert and the contractor information to the dispatcher contractor device. The method also includes displaying, with the dispatcher contractor device, the contractor information and the alert. The method also includes receiving, with the dispatcher contractor device, a selection indicating a designated contractor to perform at least one of maintenance and repair of the HVAC system based on the alert. The method also includes communicating, with the dispatcher contractor device, the selection to the server. The method also includes notifying, with the server, the field contractor device for the designated contractor of the selection.

Another method is provided and includes storing, in each of a plurality of contractor devices, contractor location data for an associated contractor, the contractor location data corresponding to a contractor location of the associated contractor. The method also includes receiving, with a server, a service request for equipment at a customer location associated with a customer device. The method also includes receiving, with the server, contractor information including the contractor location data from each of the contractor devices and contractor availability data corresponding to an availability of each contractor associated with the plurality of contractor device. The method also includes applying, with the server, a selection criteria to the received contractor information, to determine at least one potential contractor for the service request based on the application of the selection criteria. The method also includes communicating, with the server, the contractor information for the at least one potential contractor to the customer device. The method also includes receiving, with the customer device, the contractor information for the at least one potential contractor from the server. The method also includes displaying, with the customer device, the contractor information for the at least one potential contractor. The method also includes receiving, with the customer device, a selection indicating a designated contractor from the at least one potential contractor to perform the service request for the equipment. The method also includes communicating the selection from the customer device to the server. The method also includes notifying, with the server, the contractor device for the designated contractor of the selection.

A system and method for a contractor scheduling and component purchasing service is also provided.

Another system is provided and includes a database storing a plurality of faults, each fault having an indicator corresponding to whether the associated fault is designated for self-maintenance. The system also includes a monitoring system in communication with the database and configured to monitor operating parameters of an HVAC system at a customer location, to detect or predict a fault in the HVAC system based on the monitored operating parameters, to determine whether the fault is designated for self-maintenance based on the database, and to communicate an alert corresponding to the fault to a customer device associated with the HVAC system. When the alert received by the customer device indicates that the fault in the HVAC system is designated for self-maintenance, the customer device displays an identification of at least one replacement component associated with maintenance for the fault and a first interface to receive at least one of a first selection for a contractor to deliver the at least one replacement component and a second selection for purchasing the at least one replacement component through a commercial retailer.

Another method is provided and includes monitoring, with a monitoring system, operating parameters of an HVAC system at a customer location, the monitoring system being in communication with a database storing a plurality of faults, each fault having an indicator corresponding to whether the associated fault is designated for self-maintenance. The method also includes detecting or predicting, with the monitoring system, a fault in the HVAC system based on the monitored operating parameters. The method also includes determining, with the monitoring system, whether the fault is designated for self-maintenance based on the database. The method also includes communicating, with the monitoring system, an alert corresponding to the fault to a customer device associated with the HVAC system. The method also includes displaying, when the alert received by the customer device indicates that the fault in the HVAC system is designated for self-maintenance and with the customer device, an identification of at least one replacement component associated with maintenance for the fault and a first interface to receive at least one of a first selection for a contractor to deliver the at least one replacement component and a second selection for purchasing the at least one replacement component through a commercial retailer.

A computer readable storage medium is also provided and includes a computer readable storage medium storing instructions executable by a processor for monitoring, with a monitoring system, operating parameters of an HVAC system at a customer location, the monitoring system being in communication with a database storing a plurality of faults, each fault having an indicator corresponding to whether the associated fault is designated for self-maintenance. The instructions stored in the computer readable storage medium also include instructions for detecting or predicting, with the monitoring system, a fault in the HVAC system based on the monitored operating parameters. The instructions stored in the computer readable storage medium also include instructions for determining, with the monitoring system, whether the fault is designated for self-maintenance based on the database. The instructions stored in the computer readable storage medium also include instructions for communicating, with the monitoring system, an alert corresponding to the fault to a customer device associated with the HVAC system. The instructions stored in the computer readable storage medium also include instructions for displaying, when the alert received by the customer device indicates that the fault in the HVAC system is designated for self-maintenance and with the customer device, an identification of at least one replacement component associated with maintenance for the fault and a first interface to receive at least one of a first selection for a contractor to deliver the at least one replacement component and a second selection for purchasing the at least one replacement component through a commercial retailer.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The present disclosure will become more fully understood from the detailed description and the accompanying drawings, wherein:

FIG. 1A is a functional block diagram of an example system according to the present disclosure;

FIG. 1B is a functional block diagram of an example system according to the present disclosure;

FIG. 2 is a functional block diagram of an example system according to the present disclosure;

FIG. 3 is a functional block diagram of an example system according to the present disclosure;

FIG. 4 a functional block diagram of an example system according to the present disclosure;

FIG. 5A is a flowchart for a control algorithm according to the present disclosure;

FIG. 5B is a flowchart for a control algorithm according to the present disclosure;

FIG. 5C is a flowchart for a control algorithm according to the present disclosure;

FIG. 6 is a flowchart for a control algorithm according to the present disclosure;

FIG. 7 is a screenshot of a customer device according to the present disclosure;

FIG. 8 is a screenshot of a customer device according to the present disclosure;

FIG. 9 is a screenshot of a customer device according to the present disclosure;

FIG. 10 is a functional block diagram of an example system according to the present disclosure;

FIG. 11 is a flowchart for a control algorithm according to the present disclosure;

FIG. 12 is a screenshot of a contractor device according to the present disclosure;

FIG. 13 is a screenshot of a contractor device according to the present disclosure;

FIG. 14 is a flowchart for a control algorithm according to the present disclosure;

FIG. 15 is a flowchart for a control algorithm according to the present disclosure;

FIG. 16 is a flowchart for a control algorithm according to the present disclosure;

FIG. 17A is a flowchart for a control algorithm according to the present disclosure;

FIG. 17B is a flowchart for a control algorithm according to the present disclosure;

FIG. 18 is a screenshot of a customer device according to the present disclosure;

FIG. 19 is a screenshot of a contractor device according to the present disclosure;

FIG. 20 is a flowchart for a control algorithm according to the present disclosure;

FIG. 21A is a screenshot of a customer device according to the present disclosure;

FIG. 21B is a screenshot of a customer device according to the present disclosure;

FIG. 21C is a screenshot of a customer device according to the present disclosure;

FIG. 22A is a screenshot of a customer device according to the present disclosure;

FIG. 22B is a screenshot of a customer device according to the present disclosure; and

FIG. 23 is a flowchart for a control algorithm according to the present disclosure.

In the drawings, reference numbers may be reused to identify similar and/or identical elements.

### DETAILED DESCRIPTION

Example embodiments will now be described more fully with reference to the accompanying drawings.

According to the present disclosure, a contractor locator and dispatch system is provided. The system is able to coordinate and match contractor information, including contractor availability, necessary parts, necessary tools, certifications, specialties, training, and the like, with customer service requests for HVAC repair and maintenance tasks. The system is similarly able to coordinate and match contractor information with customer service requests for repair and maintenance tasks for other equipment, such as electrical systems, lighting systems, building security systems, plumbing systems, appliances, electronic equipment, and the like. In this way, customers are able to quickly and efficiently determine all potential contractors in the area that may be available to provide needed HVAC repair or maintenance. The customer can review all potential contractors and select the contractor that appears to the customer to be best suited for the task. The system then provides updated status information for the selected contractor, such as the current location of the contractor and the estimated time of arrival of the contractor at the customer's location. Likewise, the system can be used by a contractor dispatcher that receives a service request from a customer and then uses the system to identify and select an appropriate field contractor to perform the requested service. The system also allows the customer to prepay or preauthorize payment for the requested service. The system allows for both the customer and the contractor to provide feedback that is stored in the system for use by future customers and contractors.

The contractor locator and dispatch system can also be used with an HVAC monitoring system, such as the monitoring system described in the commonly-assigned patent application U.S. application Ser. No. 13/407,180, filed Feb. 28, 2012, U.S. Pub. No. 2012/0221150, titled Residential Solutions HVAC Monitoring and Diagnosis, and in the commonly-assigned patent application, U.S. application Ser. No. 13/780,617, filed Feb. 28, 2013, titled HVAC System Remote Monitoring and Diagnosis. The entire disclosures of the above applications are incorporated herein by reference. In such case, the HVAC monitoring system may generate an alert indicating that the associated HVAC system is in need of repair or maintenance. The contractor locator and dispatch system can identify and present the customer with corresponding information for appropriate contractors that may be available and suitable to perform the needed repair or maintenance. Additionally, a particular contractor may already be assigned to handle any alerts originating from the HVAC monitoring system. In the event the particular assigned contractor is not available at the time of the alert, the contractor locator and dispatch system can locate a suitable backup or overflow contractor to handle the alert.

In FIG. 1A, a functional block diagram of an example system is shown. Specifically, a contractor locator/dispatch system 10 is in communication with a customer device 12 and multiple contractor devices 14. The customer device 12 is associated with an HVAC system 16 at a customer location 18. For example, the HVAC system 16 may be installed at a residential or commercial building. In FIG. 1A, the dashed line for the customer location 18 indicates that the HVAC system 16 and customer device 12 are each associated with the particular customer location 18 where the HVAC system 16 is installed. While the customer device 12 may be physically located at the customer location 18, within the residential or commercial building, for example, the customer device 12 may also be remotely located from the HVAC system 16. The customer device 12 may be a device operated by a customer such as a homeowner or tenant living at the residential building or a building owner or tenant of the commercial building.

With reference to FIG. 1B, a functional block diagram of another example system is shown. Specifically, the example system of FIG. 1B is similar to the example system of FIG. 1A, except that in FIG. 1B the customer location 18 includes equipment 17. The equipment 17 may include electrical systems, lighting systems, plumbing systems, appliances, electronic equipment, and the like, which may periodically require maintenance or repair. As such, while the present disclosure includes various examples of a contractor locator/dispatch system 10 that includes an HVAC system in conjunction with managing and scheduling maintenance or repair for an HVAC system, it is understood, as shown in FIG. 1B, that the present disclosure is equally applicable to various types of equipment, such as electrical systems, lighting systems, plumbing systems, appliances, electronic equipment, and the like, and is not limited to only HVAC systems.

The customer device 12 and the contractor devices 14 may include mobile computing devices such as a smartphone, a tablet, or a laptop. Additionally, the customer device 12 and the contractor devices 14 may include other computing devices, such as a desktop computer. For example, the customer device 12 and the contractor devices 14 may be mobile devices, such as smartphones, executing mobile applications with appropriate programming and functionality in accordance with the present disclosure. In addition, the customer device 12 and the contractor devices 14 may include computing devices, such as smartphones, tablets, laptops, or desktop computers, with web browsers implementing appropriate programming and functionality in accordance with the present teachings.

The customer device 12 and the contractor devices 14 can communicate with the contractor locator/dispatch system 10 via an appropriate data network, such as a wide area network (WAN) or a local area network (LAN). For example, the customer device 12 and the contractor devices 14 can communicate with the contractor locator/dispatch system 10 over the Internet via an appropriate internet data connection.

In FIG. 2, a functional block diagram of the contractor device 14 is shown and includes a processing module 20, a communication module 22, a memory 24, a user input module 26, and a display module 27. The contractor device 14 may also include a GPS module 28. If, for example, the contractor device 14 is a smartphone or tablet device, the user input module 26 and the display module 27 may be a combined touchscreen device. The communication module 22 provides appropriate data access and network communication for the contractor device 14. The processing module 20 executes appropriate programming for the contractor device 14 in accordance with the present disclosure. The GPS Module 28 determines a GPS location of the contractor device 14. In the event the contractor device 14 does not include a GPS module 28, a contractor using the contractor device 14 can input the contractor's location via the user input module 26. The memory 24 includes a unique contractor identification 29, such as a unique contractor username or number, associated with the particular contractor device 14 and an associated contractor using the contractor device 14.

In FIG. 3, a functional block diagram of the customer device 12 is shown and includes a processing module 30, a communication module 32, a memory 34, a user input module 36, and a display module 37. The customer device 12 may also include a GPS module 38. If, for example, the customer device 12 is a smartphone or tablet device, the user input module 36 and the display module 37 may be a combined touchscreen device. The communication module 32 provides appropriate data access and network communication for the customer device 12. The processing module 30 executes appropriate programming for the customer device 12 in accordance with the present teachings. The GPS module 38 determines a GPS location of the customer device 12. In the event the customer device 12 does not include a GPS module 38, a customer using the customer device 12 can input the customer's location via the user input module 36. The memory 34 includes a unique customer identification 39, such as a unique customer username or number, associated with the particular customer device 12 and an associated customer using the customer device 12.

In FIG. 4, a functional block diagram of the contractor locator/dispatch system 10 is shown and includes a contractor locator/dispatch server 40, a contractor portal 42, and a customer portal 44. The contractor portal 42 and the customer portal 44 may be implemented in a variety of ways according to the present disclosure, including as an application for a smartphone or tablet, an interactive web page, and/or a desktop computer application. As discussed in further detail below, the contractor portal 42 and the customer portal 44 can provide graphical views of data available on the contractor locator/dispatch server 40. In addition, the contractor portal 42 and the customer portal 44 provide for data communication between the contractor device 14 and customer device 12, respectively.

The contractor locator/dispatch system 10 includes a contractor database 46 for storing contractor information associated with the contractor devices 14 and the associated contractors using the contractor devices 14. For example, the contractor database 46 may include a database entry for a particular contractor that connects with an associated contractor device 14 to the contractor locator/dispatch server 40 through the contractor portal 42. The contractor may be required to login with an appropriate username and password combination. The contractor device 14 may then send the contractor identification 29 stored in the memory 24 of the contractor device 14 to the contractor locator/dispatch server 40, which may then locate and retrieve a corresponding database record associated with the particular contractor. The contractor device 14 may then send its GPS location, as determined by the GPS module 28, to the contractor locator/dispatch server 40, which may update the corresponding database record associated with the particular contractor to reflect the contractor's current GPS location. Alternatively, if the contractor device 14 of the particular contractor does not include a GPS module 28, the contractor may simply input the contractor's current location.

Other contractor related information may also be stored in the contractor database 46 for use by the contractor locator/dispatch server 40. For example, if the particular contractor is currently working at a location performing a repair or maintenance task, the start time and expected completion time for the repair or maintenance task may be stored in the contractor database 46. As the particular contractor moves from task to task, this information may be continually inputted, updated, and/or determined. For example, once the particular contractor starts a particular repair or maintenance task, the particular contractor may send a notification to the contractor locator/dispatch server 40 indicating the particular repair or maintenance task. The contractor locator/dispatch server 40 may store data indicating an estimated time for completion of the particular repair or maintenance task based, for example, on historical data. Additionally, once the particular contractor completes a repair or maintenance task, the contractor may notify the contractor locator/dispatch server 40 of the completion. The contractor portal 42 may also interface with a calendar application of the contractor device 14 to determine availability of the particular contractor. For example, the contractor portal 42 may determine that the particular contractor is expected to be working on the current task for the next two hours, after which the contractor will be available for two hours, but then has a preset appointment indicated in the calendar application as being scheduled to last one hour. In this way the contractor portal 42 and the contractor locator/dispatch server 40 can continually determine and update the availability information for the particular contractor.

Further, the contractor database 46 may store data indicating an inventory of any tools associated with the particular contractor including, for example, tools carried by the contractor or located in a vehicle of the contractor. Similarly, the contractor database 46 may store data indicating an inventory of any spare or replacement parts or equipment associated with the particular contractor or located in a vehicle of the contractor. Additionally, the contractor database 46 may store data indicating any special training, any HVAC certifications, any technical specialties, or any brand or manufacturer specializations associated with the particular contractor. Additionally, the contractor database 46 may store data indicating a contracting company or service that employs or is associated with the particular contractor. Additionally, the contractor database 46 may store rating information for the particular contractor, previously inputted by other customers or retrieved from other feedback or rating services. As discussed further below, this contractor information is used by the contractor locator/dispatch server 40 to efficiently and appropriately apply selection criteria to determine a contractor or group of contractors that may be able to respond to and perform a particular repair or maintenance task.

The contractor locator/dispatch system 10 also includes a customer database 48 for storing customer information associated with the customer device 12 and the associated customer using the customer device 12. For example, the customer database 48 may include a database entry for a particular customer that connects with an associated customer device 12 to the contractor locator/dispatch server 40 through the customer portal 44. The customer may be required to login with an appropriate username and password combination. Alternatively, the customer may be allowed to use the contractor locator/dispatch system 10 as a guest user. The customer device 12 may then send the customer identification 39 stored in the memory 34 of the customer device 12 to the contractor locator/dispatch server 40, which may then locate and retrieve a corresponding database record associated with the particular customer. If the customer associated with the customer device 12 is initiating a service request due to, for example, a malfunctioning HVAC system 16, the customer portal 44 may ask whether the customer is currently located at the customer location 18 of the HVAC system 16. If so, the customer portal 44 may request and receive the GPS location of the customer device 12, as determined by the GPS module 28, for communication to the contractor locator/dispatch server 40, which may update the corresponding database record associated with the particular customer to reflect the GPS location to be associated with the service request. Alternatively, if the customer device 12 of the particular customer does not include a GPS module 38, or if the customer is not at the customer location 18 of the HVAC system 16, the customer may simply input the customer location of the HVAC system 16 associated with the service request. If the particular customer has logged in before, the customer location information may already be stored in the customer database 48.

Other customer related information may also be stored in the customer database 48 for use by the contractor locator/dispatch server 40. For example, a description of the particular components of the HVAC system 16 of the particular customer, including model and serial number information, may be stored in the customer database 48. Additionally, a history of previous repairs and maintenance on the HVAC system 16 may be stored in the customer database 48.

Additionally, other information associated with a current request for service by the particular customer may be received by the customer portal 44 from the customer device 12 and appropriately stored in the customer database 48. For example, the particular issue or problem with the HVAC system 16 may be received and stored with the request for service. For example, the particular customer may indicate that the blower on the furnace is not turning on or that the HVAC system 16 is not producing warm or cold air, as appropriate.

The customer portal 44 may also interface with a calendar application of the customer device 12 to determine availability of the particular customer. For example, the customer portal 44 may determine that the particular customer currently has a preset appointment indicated in the calendar application as being scheduled to last one hour, but is available thereafter. In this way the contractor portal 42 and the contractor locator/dispatch server 40 can continually determine and update the availability information for the particular customer. Additionally, when particular maintenance or repair work is scheduled, the customer portal 44 can update the calendar application of the customer device 12 to reflect the scheduled maintenance or repair work.

As discussed in further detail below, the customer database 48 may also store rating information for the particular customer, previously inputted by other contractors or retrieved from other feedback or rating services.

The contractor locator/dispatch system 10 also includes a mapping module 49 for determining routes between particular locations, including, for example, a current contractor location and a particular customer location 18. The mapping module 49 may utilize or interface with a third-party mapping application, such as GOOGLE MAPS™, MAPQUEST™, YAHOO! MAPS™, and the like. Additionally, the mapping module 49 may store map information for a predetermined geographic area, such as a particular city. Further, as discussed below, the mapping module 49 may determine a route that accounts for one or more stops between a current location of a particular contractor and a destination, such as a customer location 18. For example, the route may include a stop at a retail shop of the contractor to retrieve additional tools, replacement parts, or other equipment. Additionally, the route may include a stop at a location of another contractor to retrieve additional tools, replacement parts, or other equipment. For example, contractors may enter into predetermined agreements for the resale of replacement parts between contractors located in the field. In other words, replacement parts retrieved from another contractor's vehicle may be sold at a higher price than would be the case if the part were purchased from a normal retail store.

While many of the contractor devices 14 may be associated with contractors working at particular customer locations 18 in the field, a contractor device 14 may also be associated with a permanent location such as a retail shop associated with the contractor. The contractor device 14 located at the permanent location may serve as a dispatch device and may manage one or more contractors working in the field at various different customer locations 18. The contractor devices 14 associated with contractors working at customer locations 18 in the field may be referred to as field contractor devices 14. The contractor device 14 associated with the permanent locations such as the retail shop associated with the contractor may be referred to as a dispatcher contractor device 14.

With reference to FIG. 5A, a control algorithm 500 for updating contractor information is shown. The control algorithm 500 may be performed, for example, by the contractor locator/dispatch server 40 and starts at 502. At 504, the contractor locator/dispatch server 40 receives contractor location and status information from a contractor device 14. As discussed above, the contractor location information for a particular contractor may be determined by the GPS module 28 of the contractor device 14. The status information may include information related to the particular contractor's current activity and availability. For example, the status information may indicate that the particular contractor just started or just completed a particular repair or maintenance task. The status information may also indicate an estimated percentage of completion of a particular repair or maintenance task. The status information may also indicate that an issue or problem has been encountered during a particular repair or maintenance task. For example, an unexpected problem with or malfunction of the HVAC system 16 under repair or maintenance may have been discovered, resulting in additional time needed to complete the repair or maintenance task. Additionally, the status information may indicate that an additional replacement part or tool is needed that the particular contractor may not currently possess, thereby requiring the contractor to travel to another location, such as a retail shop or another contractor location to retrieve the needed replacement part or tool. Additionally, the status information may indicate that certain parts from the particular contractor's inventory have now been used or that a tool has been broken or lost. At 506, the contractor locator/dispatch server 40 updates the contractor database 46 with the contractor location and status information and loops back to 504.

For example, with respect to status and availability information, a graphical interface on the contractor device 14 may include a virtual button for the contractor to select to indicate whether the contractor is available or unavailable. For example, when the contractor begins a repair or maintenance task at a customer location, 18, the contractor may select the virtual button to indicate the contractor is currently unavailable. Additionally, once the contractor completes the repair or maintenance task, the contractor may select the virtual button again to indicate that the contract is now available again.

Alternatively, the contractor device 14 may send only the location information for the contractor and the contractor may separately submit availability and status information via other means. For example, the contractor may communicate availability and status information via telephone, email, or text message, for example, to the contractor locator/dispatch server 40. Alternatively, the contractor may communicate availability and status information via telephone, email, or text message to another contractor device 14 that is serving as a dispatcher contractor device 14, which is described in further detail below. In such case, the dispatcher contractor device 14 may then communicate the particular contractor's availability and status information to the contractor locator/dispatch server 40.

The control algorithm 500 may be performed continually or periodically for each of the contractor devices 14 connected to or in communication with the contractor locator/dispatch server 40.

With reference to FIG. 5B, a control algorithm 510 for receiving and handling a service request is shown. The control algorithm 510 may be performed, for example, by the contractor locator/dispatch server 40 and starts at 512. At 514, the contractor locator/dispatch server 40 receives a service request from a customer device 12. For example, the service request may be inputted by a customer associated with the customer device 12 indicating an issue, problem, or malfunction with an associated HVAC system 16. The service request includes a location of the HVAC system 16 based on a GPS location generated by a GPS module 38 of the customer device 12, as discussed above, or based on user input. The service request may also include additional information regarding the HVAC system 16 and the issue, problem, or malfunction associated with the service request. For example, the service request may indicate the result of the problem, i.e., that the HVAC system 16 is not producing warm or cool air. Additionally, the service request may be more detailed, indicating a particular component is malfunctioning, i.e., the thermostat display is not working or the blower is not working. Additionally, if information related to the HVAC system 16 is not already stored in the customer database 48, the service request may include information regarding the components of the HVAC system 16, i.e., that the outdoor condensing unit is a model ABC condensing unit, manufactured by D, with capacity E, etc.

The service request may also include availability information for the customer. For example, as discussed above, the customer portal 44 may interface with a calendar application of the customer device 12 to determine the customer's availability to be at the customer location 18 at the time of the service.

Additionally, the service request may indicate whether the customer requires or requests the contractor to have any particular HVAC certifications, technical specialties, manufacturer brand specialties, or a particular feedback rating.

At 516, the contractor locator/dispatch server 40 applies specified contractor selection criteria based on the service request and based on the contractor information from the contractor database. The application of contractor selection criteria is discussed in further detail below in conjunction with FIG. 6. As described therein, the application of the search criteria results in a determined subgroup of contractors that may be available and qualified to handle the particular service request.

At 518, the contractor locator/dispatch server 40 determines the subgroup of contractors based on the applied search criteria and sends corresponding contractor information for the subgroup of contractors to the customer device 12 for display. For example, as discussed below, an example screenshot of a customer device displaying particular contractors is shown and discussed in conjunction with FIG. 7.

At 520, the particular customer selects a particular contractor from the displayed subgroup of contractors and the contractor selection is received by the contractor locator/dispatch server 40.

At 522, the contractor locator/dispatch server 40 notifies the particular contractor corresponding to the contractor selection received from the customer device 12. Specifically, the contractor locator/dispatch server 40 notifies the contractor device 14 of the particular contractor and updates the availability and status information for the contractor in the contractor database 46 to indicate that the contractor is scheduled to handle the particular service request next, or at the scheduled time based on availability of the particular contractor and the particular customer. The algorithm ends at 524.

With reference to FIG. 5C, a control algorithm 530 for displaying and receiving contractor information is shown. The control algorithm 530 may be performed, for example, by a customer device and starts at 532. At 534, the customer device 12 displays the contractor selection, i.e., the previously selected contractor to handle the service request, along with the location and status information associated with the selected contractor. For example, as discussed below, an example screenshot of a customer device displaying location and status information for a selected contractor is shown and discussed in conjunction with FIG. 8.

At 536, the customer device 12 receives updated contractor location and status information and then loops back to 534 to display the contractor location and status information. For example, as the selected contractor travels to the customer location 18, the contractor's location information is updated and displayed, showing travel towards the customer location 18.

With reference to FIG. 6, a control algorithm 600 for applying specified contractor selection criteria, based on a received service request and based on contractor information, is shown. As discussed above, the functionality of FIG. 6 is encapsulated in block 516 of FIG. 5B. The control algorithm 600 may be performed, for example, by the contractor locator/dispatch server 40 and starts at 602. The contractor locator/dispatch server 40 applies the specified contractor selection criteria to a set of contractors from the contractor database 46. For example, the contractor locator/dispatch server 40 may apply the selection criteria to all contractors with associated records stored in the contractor database 46. Alternatively, the contractor locator/dispatch server 40 may apply the selection criteria to all contractors that have logged into the contractor locator/dispatch system 10 within a designated time period, for example, within the past day.

At 604, the contractor locator/dispatch server 40 applies availability criteria. The availability criteria may specify that only contractors that are currently available should be included in the determined subgroup of contractors for consideration to perform the service request. Alternatively, the availability criteria may specify that contractors that are currently available or that will be available within a specified time period, for example, the next hour or two hours, should be included in the determined subgroup of contractors for consideration to perform the service request. The availability criteria may be predetermined and set by a system administrator or may be specified by individual customers. Additionally, default availability criteria may be specified by the system administrator, subject to individual customization by individual customers. Additionally, particular customers may change the specified availability criteria from service request to service request. For example, a service request to repair a malfunctioning HVAC system 16 that is not producing heat may include availability criteria indicating that only contractors that are currently available should be included in the subgroup of contractors, while a service request for changing a furnace filter may include availability criteria indicating the availability window could be as long as a day, a few days, or even a week.

Alternatively, the availability criteria may be applied by ranking all contractors based on availability, and then selecting a predetermined number of contractors based on the ranking. For example, the next five available contractors, ranked in order of earliest availability, may be included in the subgroup.

After applying the availability criteria, the contractor locator/dispatch server 40 proceeds to 606 and applies the necessary parts criteria. The contractor locator/dispatch server 40 may determine a list of necessary parts to perform the service request based on information received with the service request. For example, the service request may specify necessary parts. Alternatively, the service request may include enough information about the equipment for the contractor locator/dispatch server to determine the list of necessary parts. The contractor locator/dispatch server 40 may then include only those contractors in the subgroup of contractors that either have the necessary parts currently with them, or have access to the necessary parts by making a stop at a retail shop, at a contractor base, or at a location of another contractor. If a particular contractor does not have access to the necessary parts, the contractor may be excluded from the subgroup of contractors for consideration to perform the service request.

After applying the necessary parts criteria, the contractor locator/dispatch server 40 proceeds to 608 and applies the necessary tools criteria. Similar to the necessary parts criteria, the contractor locator/dispatch server 40 may determine a list of tools necessary to perform the service request based on information received with the service request. For example, the service request may specify necessary tools. Alternatively, the service request may include enough information about the equipment for the contractor locator/dispatch server 40 to determine the list of necessary tools. The contractor locator/dispatch server 40 may then include only those contractors in the subgroup of contractors that either have the necessary tools currently with them, or have access to the necessary tools by making a stop at a retail shop, at a contractor base, or at a location of another contractor. If a particular contractor does not have access to the necessary tools, the contractor may be excluded from the subgroup of contractors for consideration to perform the service request.

After applying the necessary tools criteria, the contractor locator/dispatch server 40 proceeds to 610 and applies the proximity/routing criteria. The contractor locator/dispatch server 40 determines a route for the contractor to travel from the contractor's current location to the customer location 18, including any stops to acquire any necessary parts or necessary tools. Once the routes are calculated for each contractor still under consideration for inclusion in the subgroup, the distances of each route may be compared with a predetermined distance threshold. For example, the distance threshold may be thirty miles or sixty miles, for example. Additionally, the proximity/routing criteria may simply indicate that all contractors located within a certain geographic area, like a city or county, for example, should be included. A system administrator may set a default distance threshold for the proximity/routing criteria, which can then be modified by particular customers.

Alternatively, the proximity/routing criteria may be applied by ranking all contractors based on distance to the customer location 18, and then selecting a predetermined number of contractors based on the ranking. For example, the five closest contractors may be included in the subgroup.

After applying the proximity/routing criteria, the contractor locator/dispatch server 40 proceeds to 612 and applies qualification criteria. For example, the qualification criteria may be determined based on the service request and may indicate that the contractor have certain HVAC certifications, certain technical specialties, certain manufacturer brand specifications, certain training, etc. The qualification criteria may be set to a default value by a system administrator, may be determined from information with the service request, or may be specified by the customer.

After applying the qualification criteria, the contractor locator/dispatch server 40 proceeds to 614 and applies rating criteria. For example, the rating criteria may indicate that only contractors with a certain average feedback rating be included in the subgroup. As discussed below, contractors may be rated, for example, on a scale of one to five, with one being poor and five being excellent. The rating criteria may indicate that only contractors with an average rating of four or higher be included in the subgroup. The rating criteria may be set to a default value by a system administrator, may be determined from information with the service request, or may be specified by the customer.

After applying the rating criteria at 614, the contractor locator/dispatch server 40 proceeds to 616 and returns the subgroup of contractors that meet all of the criteria. The algorithm ends at 618.

Although an example order for applying the various selection criteria metrics is shown in FIG. 6, any other different order of applying the selection criteria metrics may be used instead. Also, in some instances only a subset of the various selection criteria metrics shown in FIG. 6 may be used. A system administrator of a customer may customize the particular set of selection criteria metrics used. Additionally, the system may determine the set of selection criteria metrics to use based on information received in a service request or alert.

With reference to FIG. 7, an example screenshot of a customer device 12 displaying particular contractors is shown. The example screenshot may be displayed on the customer device 12 after all selection criteria have been applied. From the display shown in FIG. 7, a customer may select a particular contractor to handle a particular service request.

The screenshot includes a graphical map display 700 and a contractor information display 702. The graphical map display 700 shows a geographical road map of an area that includes the customer location. In this case, for example, the customer location is shown as “Your Location” at 704. Additionally, the locations of various contractors in the displayed area are also shown. For example, Contractor A is shown at 706 on Beech Rd., Contractor B is shown at 710 on Ash Ct., and Contractor C is shown at 708 traveling on the interstate. In this example, Contractors A and B are already at customer locations performing maintenance or repairs and are currently unavailable, while Contractor C is traveling and is currently available. Additionally, the graphical map display 700 shows the location of a retail shop 712, which may, for example, provide parts or tools for the contractors.

The contractor information display 702 displays corresponding contractor information for the contractors. For example, the contractor information display 702 includes a table with columns indicating: “Contractor Name,” “Phone Number,” “Company,” “Certifications/Specialties,” “Rating,” “Parts?,” “Tools?,” “Availability,” Est. Arrival Time,” and “Est. Completion Time.” While the contractor information display 702 shows “ . . . ” in each data entry field, it is understood that in practice these fields would be filled in with appropriate information. The “Contractor Name” and “Phone Number” correspond to the associated contractor's name and phone number. The “Company” corresponds to a company that employs the particular contractor. The “Certifications/Specialties” field corresponds to any specialized HVAC certifications, technical specialties, or manufacturer or brand specialties. The “Rating” field corresponds to an average feedback rating associated with the particular contractor. The “Parts?” field indicates whether the particular contractor has the necessary parts available for the service request. The “Tools?” field indicates whether the particular contractor has the necessary tools available for the service request. The “Availability” field indicates whether the particular contractor is currently available or, if not, when the particular contractor is estimated to become available. The “Est. Arrival Time” field indicates an estimated arrival time for the contractor at the customer location 18, accounting for the particular contractor's availability, and the travel time associated with the route to the customer location 18. The “Est. Completion Time” field indicates the estimated time for the particular contractor to complete the maintenance or repair associated with the service request, accounting for the contractor's availability, the travel time, and the estimated time needed to complete the maintenance or repair.

With reference to FIG. 8, another example screenshot of a customer device 12 displaying particular contractors is shown. The screenshot of FIG. 8 is similar to the screenshot of FIG. 7, except that a particular contractor, specifically Contractor C, has been selected within the graphical map display 700 for performance of the service request. When the particular contractor is selected, a photo of the particular contractor may be displayed in a display window 800. In addition to the photo, other contractor information associated with the particular contractor may be displayed. For example, as shown, the contractor name “Contractor C” and the current estimated arrival time for the contractor at the customer location 18 is displayed. As Contractor C travels towards the customer location at 704, the graphical map display is updated and the contractor location indicator for Contractor C at 708 is shown at the updated locations on the route towards the customer location 704.

Additionally, in the event that the selected contractor is taking too long to arrive at the customer location 18, the customer may select a different contractor to handle the service request. For example, if the initially selected contractor is running late, and another contractor, perhaps at a closer location, becomes available, the customer may switch to the closer contractor. In such case, the contractor locator/dispatch system 10 makes appropriate updates to the contractor database 46, customer database 48, appropriate contractor devices 14, and the customer device 12.

With reference to FIG. 9, another example screenshot of a customer device 12 is shown. FIG. 9 is similar to FIG. 8, except that additional details associated with the service request are shown in a service request information display window 900 and in a pre-authorization/pre-payment display window 902.

At 900, additional detailed information corresponding to the service request is shown. For example, a title of the service request is included at the top of the display window 900. Additionally, the estimated arrival time and a description of the work to be performed are displayed in the display window 900. Further, the necessary parts for the repair are shown, along with the estimated cost of the parts. Further, the estimated cost of labor is shown in the display window 900. Finally, the estimated total cost of the repair is shown in the display window 900.

At 902, the customer may use the customer device 12 to provide pre-authorization or pre-payment of designated amounts for performance of the service request. For example, the customer may indicate that pre-authorization is provided up to a certain designated dollar amount. The customer may enter the pre-authorization amount in the pre-authorization amount field in the display window 902 and click the “Submit” button. The pre-authorization info is then communicated from the customer device 12 to the contractor locator/dispatch system 10 and the contractor device 14 handling the particular service request or alert. Further, the customer may pre-pay the particular contractor by entering a pre-payment amount in the pre-pay amount field in the display window 902 and click the “Submit” button. By clicking the submit button, the customer device 12 may proceed with processing payment via associated payment methods, such as via the customer's bank account, the customer's credit card, or an online payment service, such as PAYPAL™. As an example, the total estimated cost for certain maintenance or repair may be $500. A customer may provide pre-authorization for the particular contractor to proceed with work up to $500. Additionally, the customer may pre-pay half of the anticipated amount due, for example, ahead of time.

A particular contractor may have specific requirements for pre-authorization and pre-payment and a customer can use the display window 902 to meet any such requirements. For example, a particular contractor may retrieve and review feedback and rating data for the customer from the customer database 48. Based on the feedback and rating data for the customer, the particular contractor may determine whether pre-payment and/or pre-authorization for any maintenance or repair tasks should be required and, if so, what those amounts should be. For example, if the feedback and rating data indicates that a particular customer has not paid previous contractors, has been slow to pay previous contractors, or previously asserted that the amount of a repair was not authorized, the particular contractor may require pre-payment or pre-authorization at an appropriate amount.

With reference to FIG. 10, a functional block diagram of another example system is shown. Specifically, the contractor locator/dispatch system 10 is in communication with a monitor system 102 as well as the customer device 12 and multiple contractor devices 14. The monitor system 102 is in communication with a monitor module 100 associated with the HVAC system 16 at the customer location 18. For example, the monitor system 102 may be an HVAC monitoring system, such as the monitoring system described in the commonly-assigned patent application U.S. application Ser. No. 13/407,180, filed Feb. 28, 2012, U.S. Pub. No. 2012/0221150, titled Residential Solutions HVAC Monitoring and Diagnosis, and in the commonly-assigned patent application, U.S. application Ser. No. 13/780,617, filed Feb. 28, 2013, titled HVAC System Remote Monitoring and Diagnosis. The entire disclosures of the above applications are incorporated herein by reference. The monitor module 100 may use sensors to monitor operating parameters of the HVAC system 16. For example, the monitor module 100 may utilize temperature sensors, pressure sensors, current sensors, voltage sensors, condensate sensors, and the like, to collect operating parameter data related to the operation of the HVAC system 16. The monitor module 100 may communicate the operating parameter data to the monitor system 102, which may be remote from the customer location. The monitor system 102 may then review and analyze the operating parameter data to determine whether the HVAC system 16 is operating normally, or whether there are any issues, such as a malfunction. Additionally, based on analysis of the operating parameter data, the monitor system 102 may be able to predict when components of the HVAC system 16 are about to fail. When the monitor system 102 detects an issue with the HVAC system 16, such as a malfunction or a predicted component failure, the monitor system 102 may generate an alert corresponding to the issue. The monitor system 102 may communicate the alert to the customer device 12 and/or to the contractor locator/dispatch system 10.

The monitor system 102, customer device 12, and contractor locator/dispatch system 10 may be configured to automatically schedule and dispatch a contractor to travel to the customer location 18 to address the issue corresponding to the alert. For example, if the detected issue is a component failure that results in ceased operation of the HVAC system 16, the contractor locator/dispatch system may assign a contractor to travel to the customer location and handle the alert. Additionally, the monitor system 102, customer device 12, and contractor locator/dispatch system 10 may be configured to deliver the alert to the customer device 12 and then wait for the customer device to generate a corresponding service request before assigning a contractor. In this instance, contractor locator/dispatch system 10 defers to the customer to determine whether and when to schedule a contractor to address the issue indicated by the alert. For example, if the alert indicates that the furnace filter needs to be replaced within the next two weeks, the monitor system 102 may simply deliver the alert to the customer device and allow the associated customer to generate a corresponding service request, with the customer device 12, as needed.

While multiple contractor devices 14 can be in communication with the contractor locator/dispatch system 10, some of the contractor devices 14 may be associated with mobile contractors operating in the field while traveling to different customer locations to perform HVAC system maintenance and repair tasks. Such contractor devices 14 may be referred to as field contractor devices and the associated contractors may be referred to as field contractors. Other contractor devices 14 may be associated with a central operation headquarters, such as a retail shop, that is associated with multiple field contractors. Such a contractor device 14 may monitor and review multiple service requests and/or alerts and may serve as a dispatcher to assign individual service requests or alerts to individual field contractors. Such a contractor device 14 used to assign requests or alerts to individual field contractors may be referred to as a dispatcher contractor device 14 and the associated contractor may be referred to as a dispatcher.

With reference to FIG. 11, a control algorithm 300 for dispatch and assignment of field contractors to handle individual service requests or alerts is shown. The control algorithm 300 may be performed by the contractor locator/dispatch system 10 and starts at 310. At 314, the contractor locator/dispatch system 10 receives a service request from a customer device 314 or an alert from the monitor system 102. The contractor locator/dispatch system 10 may compile a list, for example, of current service requests and alerts. At 316, the contractor locator/dispatch system 10 applies contractor selection criteria to a determined set of contractors from the contractor database 46. Application of selection criteria is described above, for example, in conjunction with FIG. 6. At 318, the contractor locator/dispatch system 10 determines the subgroup of contractors based on application of the selection criteria and communicates information corresponding to the subgroup of contractors to a dispatcher contractor device 14 for display on the dispatcher contractor device 14 to a dispatcher.

At 320, the dispatcher selects a particular field contractor for assignment of the particular service request or alert and the contractor locator/dispatch system 10 receives the selected field contractor assignment. At 322, the contractor locator/dispatch system 10 notifies the field contractor of the assignment and updates the contractor database 46 to reflect the assignment. At 324, the control algorithm ends.

With reference to FIG. 12, a screenshot of a field contractor device 14 showing a list of outstanding service requests or alerts is shown. The screenshot includes a graphical map display 110 that displays a map of a geographic area, along with indicators for individual customers corresponding to the outstanding service requests or alerts. The screenshot also includes a service request/alert information display 112 that includes information corresponding to the service requests and alerts. In the graphical map display 110, indicators are shown for three customers, namely Customer A 118, Customer B 116, and Customer C 114.

The contractor information display 702 includes a table with columns indicating: “Customer Name,” “Phone Number,” “Address,” “Summary,” “Time,” “System Type,” “Expected Replacement Parts,” “Expected Service Needed,” “Assigned Contractor,” and “More Data.” The “Customer Name,” “Phone Number,” and “Address” fields correspond to the name, phone number, and address of the customer for the associated service request or alert. The “Summary” field includes a description of the service request or alert and any information related to the corresponding issue that precipitated the service request or alert. The “Time” field corresponds to the time of the service request or alert. The “System Type” field corresponds to the type of HVAC system at the corresponding customer location, for example, a heat pump system, an HVAC system with a variable capacity compressor, etc. The “Expected Replacement Parts” field indicates the expected list of replacement parts needed to perform the service request or to handle the alert. The “Expected Service Needed” field indicates the expected type of work or serviced needed to be performed to handle the particular service request or alert. The “Assigned Contractor” field indicates a currently assigned field contractor to handle the service request or alert. If a field contractor has not yet been assigned to the particular service request or alert, the “Assigned Contractor” field may be blank. The “More Data” field indicates any additional miscellaneous data associated with the particular service request or alert. For example, the “More Data” field may include particular operating parameter data from a corresponding monitor module 100 of the HVAC system 16.

With reference to FIG. 13, another screenshot of a field contractor device 14 showing a list of outstanding service requests or alerts is shown. The screenshot of FIG. 13 is similar to the screenshot of FIG. 12 except that in FIG. 13 the graphical map display 110 includes indicators for contractor locations in addition to customer locations. For example, contractor A is located at the customer location 122 for customer A and contractor B is located at the customer location 120 for customer B. Contractor C 124 is shown traveling on the interstate, en route to the customer location 126 for customer C.

For customers that utilize the monitor system 102 and have a monitor module 100 installed on their HVAC system 16, the customer may have executed a monitoring agreement with a monitoring company that operates the monitor system 102. For example, the customer may rent the monitor module 100 from the monitoring company and may pay a monthly subscription fee for the monitoring service provided by the monitoring company with the monitor system 102.

In such case, the customer may have a predetermined contractor already designated to handle any alerts or service requests. For example, when an alert or service request is received by the monitor system 102 and/or contractor locator/dispatch system 10, the predetermined contractor may be automatically notified and scheduled to perform any necessary maintenance or repairs. In the event the predetermined contractor is not available at the time of the service request or alert, a predetermined overflow contractor may then be assigned to handle the service request or alert. Alternatively, the contractor locator/dispatch system 10 may be configured to automatically assign such a service request or alert to the predetermined contractor and, if the predetermined contractor is not available, to then apply selection criteria, as discussed above, to identify a suitable contractor to handle the service request or alert.

With reference to FIG. 14, a control algorithm 130 for assigning a predetermined contractor or a predetermined overflow contractor to handle a received alert or service request is shown. The control algorithm 130 may be performed by the contractor locator/dispatch system 10 and starts at 131. At 131, the contractor locator/dispatch system 10 receives notification of an alert or service request. At 133, the contractor locator/dispatch system 10 determines the associated predetermined contractor designated to handle the alert or service request. For example, a customer record in the customer database 48 may include information for a designated contractor to serve as the predetermined contractor for any alerts or service requests associated with the particular customer. At 134, the contractor locator/dispatch system 10 determines whether the associated contractor is available, or whether the associated contractor will be available within a predetermined time period. At 135, when the associated contractor is not available and will not become available within the predetermined time period, the contractor locator/dispatch system 10 assigns the alert or service request to a designated overflow contractor and notifies the overflow contractor. For example, a contractor record for the associated contractor in the contractor database 46 may indicate a designated overflow contractor to handle service requests or alerts from monitored customers when the predetermined contractor is not available. At 136, the contractor locator/dispatch system 10 notifies the customer of the contractor selection/assignment. At 137, when the associated contractor is available, the associated contractor is notified of the service request or alert, and the customer is notified at 136. The control algorithm ends at 138.

With reference to FIG. 15, a control algorithm 140 for receiving a contractor selection, for handling an alert from a monitor system 102, from a customer utilizing a monitoring service with a monitor module 100 and monitor system 102 is shown. The control algorithm 140 may be performed by the contractor locator/dispatch system 10 and starts at 141. At 142, an alert is received by the contractor locator/dispatch system 10 from the monitor system 102 based on data analysis of data received from the monitor module 100. At 143, the contractor locator/dispatch system 10 applies selection criteria as described above. Specifically, application of selection criteria is described in conjunction with FIG. 6 above. At 144, the contractor locator/dispatch system 10 determines the subgroup of contractors, based on application of the selection criteria, and communicates information corresponding to the subgroup of contractors to the customer device 12 for display with location and status information. An example screenshot of such a display is discussed above with respect to FIG. 7. At 145, the customer selects a particular contractor with the customer device 12 and the contractor locator/dispatch system 10 receives the selection. An example screenshot showing a selected contractor is discussed above in conjunction with FIGS. 8 and 9. At 146, the contractor locator/dispatch system 10 notifies the selected contractor. At 147, the control algorithm 140 ends.

With respect to FIG. 16, a control algorithm 150 for notifying contractors of potential service requests and alerts, and acceptance from a particular contractor, is shown. The control algorithm 150 may be performed by the contractor locator/dispatch system 10 and starts at 151. At 152, the contractor locator/dispatch system 10 receives a request for service from a customer device 12 or an alert from a monitor system 102. At 153, the contractor locator/dispatch system 10 applies selection criteria, as discussed above. Specifically, application of selection criteria is discussed above in conjunction with FIG. 6. At 154, the contractor locator/dispatch system 10 notifies all contractors that meet the selection criteria of the service request or alert. Specifically, the contractors may receive a notification on their corresponding contractor devices 14 indicating the service request or alert. At 155, the contractor locator/dispatch system 10 may receive an acceptance from one of the contractors indicating that the particular contractor has agreed to perform the repair or maintenance tasks associated with the particular service request or alert. At 156, the contractor locator/dispatch system 10 notifies the customer of the acceptance of the service request or alert by the particular contractor. At 157, the control algorithm ends.

After completion of a particular repair or maintenance tasks by a contractor, the contractor locator/dispatch system 10 may request and receive feedback regarding the service from both the contractor and the customer. For example, with respect to FIG. 17A, a control algorithm 200 for requesting and receiving feedback from a customer is shown. The control algorithm 200 may be performed by the contractor locator/dispatch system 10 and starts at 201. At 202, the contractor locator/dispatch system 10 receives notification that the maintenance or repair tasks have been completed. For example, the notification of the completed service request may be provided by the customer device 12 and/or the contractor device 14. At 203, the contractor locator/dispatch system 10 requests and then receives feedback regarding the contractor's performance from the customer via the customer device 12. At 204, the contractor locator/dispatch system 10 updates the contractor database 46 based on the received feedback. Specifically, a contractor record in the contractor database 46 is updated appropriately to reflect the newly received feedback regarding the associated contractor. The control algorithm 200 ends at 205.

Similarly, with respect to FIG. 17B a control algorithm 206 for requesting and receiving feedback from a contractor is shown. The control algorithm 206 may be performed by the contractor locator/dispatch system 10 and starts at 207. At 208, the contractor locator/dispatch system 10 receives notification that the maintenance or repair tasks have been completed. For example, the notification of the completed service request may be provided by the customer device 12 and/or the contractor device 14. At 209, the contractor locator/dispatch system 10 requests and then receives feedback regarding the customer from the contractor via the contractor device 14. At 210, the contractor locator/dispatch system 10 updates the customer database 48 based on the received feedback. Specifically, a customer record in the customer database 48 is updated appropriately to reflect the newly received feedback regarding the associated customer. The control algorithm 200 ends at 205.

With respect to FIG. 18, a screenshot showing a feedback form displayed on a customer device 12 for receiving feedback regarding a contractor is shown. For example, the screenshot includes feedback windows 170, 172, and 174. In feedback window 170, the customer is asked to answer “yes” or “no” questions including: Did the contractor arrive at the expected time?; Did the contractor complete the service request at the expected time?; Did the contractor fix the problem?; Did the contractor have all of the necessary tools for the service request?; Did the contractor have all of the necessary parts for the service request?; Does the contractor need to return to complete additional work?; and Would you recommend this contractor to someone else?

In feedback window 172, the customer is asked to rate the contractor on a scale from one to five with one being poor and five being excellent. In feedback window 174, the customer is asked to input any additional comments regarding the contractor. The customer's feedback responses are then received by the contractor locator/dispatch system 10 and stored in a contractor record corresponding to the particular contractor in the contractor database 46.

With respect to FIG. 19, a screenshot showing a feedback form displayed on a contractor device 12 for receiving feedback regarding a customer is shown. For example, the screenshot includes feedback windows 180, 181, 182, and 183. In feedback window 180, the contractor is asked to answer “yes” or “no” questions including: Was the customer at the service request location at the expected time?; Did the customer provide access to all necessary areas of the location?; Was the work location clean?; Would you recommend working for this customer to another contractor?; and Did the customer pay in full for the work that was performed?.

In feedback window 181, the contractor is asked to rate the customer on a scale from one to five with one being poor and five being excellent. In feedback window 182, the contractor is asked to input any additional comments regarding the customer. In feedback window 183, the contractor is asked to provide a summary of the work performed, including any parts or equipment that were repair or replaced during the repair or maintenance tasks. The contractor's feedback responses are then received by the contractor locator/dispatch system 10 and stored in a customer record corresponding to the particular customer in the customer database 48.

In addition to receiving feedback from the contractors and customers, the contractor locator/dispatch system may also receive feedback from other third-party feedback or ratings services. The third-party feedback may then be incorporated and appropriately stored in customer and contractor records in the customer database 48 and contractor database 46.

After completion of a repair or maintenance task, the monitor system 102 may continue to monitor the operating parameters of the HVAC system 16 via the monitor module 100 and may evaluate whether the performed repair or maintenance was effective in improving the performance of the HVAC system 16.

For example, with respect to FIG. 20, a control algorithm 190 for evaluating the effectiveness of a repair or service request and communicating results to a contractor or customer is shown. The control algorithm 190 may be performed by the monitor system 102, in conjunction with the contractor locator/dispatch system 10, and starts at 191. At 192, the monitor system receives a notification that repair or maintenance tasks associated with a service request or alert have been completed. At 193, the monitor system 102 continues to monitor the HVAC system 16 with the monitor module 100. At 194, the monitor system 102 determines an operational cost change by comparing operational data from before the repair or maintenance tasks with operational data from after the repair or maintenance tasks. For example, the monitor system 102 may compare power usage of the HVAC system 16 from before the repair or maintenance tasks with power usage of the HVAC system 16 from after the repair or maintenance tasks to determine whether power usage of the HVAC system 16 has improved.

Based on the determining, at 195 the monitor system 102 evaluates an effectiveness of the repair or maintenance tasks by, for example, determining whether the operating data indicates an increase or a decrease in performance of the HVAC system. For example, the monitor system 102 may evaluate whether the repair or maintenance task resulted in increased or decreased power consumption. At 196, the monitor system 102 may communicate data indicating the effectiveness of the repair to the customer device 12, the contractor device 14, or to the contractor locator/dispatch system 10 for storage in the customer database 48 or the contractor database 46. Additionally, the contractor locator/dispatch system 10 may communicate the data indicating the effectiveness of the repair to the customer device 12 and/or the contractor device 14.

As described above, the contractor locator/dispatch system 10 may be accessible and used by multiple contractors all working for a single contractor service or company. Alternatively, the contractors using the contractor locator/dispatch system 10 may be independent contractors or may be contractors working for different contractor services or companies. For example, the contractor locator/dispatch system 10 may be open to any contractors that sign up for the system and agree to predetermined terms and condition of use. Alternatively, participation in the contractor locator/dispatch system 10 may be limited to those contractors that have completed certain training programs or certification requirements. In this way, an administrator of the contractor locator/dispatch system 10 may insure that the participating contractors meet certain minimum requirements for training and certification so as to increase the likelihood that customers using the contractor locator/dispatch system 10 will receive high quality service. Additionally, the contractor locator/dispatch system 10 may provide “tiers” of training or certification levels along with different levels of repair or maintenance tasks associated with each level or tier of training or certification.

As described above, the contractor locator/dispatch system 10 may be used with or without an associated monitor system 102. When a contractor handles a service request from a customer that is not using the associated monitor system 102, the contractor may take the opportunity to educate the customer as to the benefits of utilizing a monitor system 102 and monitor module 100 in the future. In this way, the contractor may operate as a sales person in an effort to have the customer decide to purchase the monitoring service using the monitor system 102 and the monitor module 100.

As described above, the contractor locator/dispatch system 10 is able to minimize the time necessary to manage and handle repairs and maintenance tasks and to more efficiently use the contractor's time and resources. Additionally, the contractor locator/dispatch system 10 allows the ability to coordinate calendars and scheduling based on the location of contractor vehicles, the location of the necessary tools and parts, the estimated time of the associated tasks, and the contractor's training and skill level. Additionally, the contractor locator/dispatch system 10 is able to more efficiently route the contractors in the field to optimize travel time and fuel usage. Additionally, the contractor locator/dispatch system 10 is able to schedule necessary tune-ups or regular maintenance, for example, at a time when it is most efficient for the contractor, for example at a time when the contractor will already be in the area and has availability.

In some implementations, the monitor system 102 determines whether a fault within the HVAC system 16 is a non-critical fault that is serviceable, for example, by the home owner or customer without direct involvement of a professional contractor. For example, as described above with reference to FIG. 10, the monitor module 100 may utilize temperature sensors, pressure sensors, current sensors, voltage sensors, condensate sensors, and the like, to collect operating parameter data related to the operation of the HVAC system 16. The monitor module 100 may communicate the operating parameter data to the monitor system 102, which may be remote from the customer location. The monitor system 102 may then review and analyze the operating parameter data to determine whether the HVAC system 16 is operating normally, or whether there are any issues, such as a fault or malfunction. For example, the issue may be a faulty or dirty furnace filter within the HVAC system 16. Additionally, based on analysis of the operating parameter data, the monitor system 102 may be able to predict when components of the HVAC system 16 are about to fail.

When the monitor system 102 detects an issue with the HVAC system 16, such as a fault or a predicted component failure, the monitor system 102 may determine whether the issue is a non-critical issue that is serviceable, for example, by the home owner or customer without involvement or assistance of a professional contractor to make a repair or replace a system component. For example, the monitor system 102 may compare the issue to a list of predefined issues or faults. The list of predefined issues or faults may be stored in a database, including, for example, a look-up table, of known faults preprogrammed and stored in the monitor system 102. Alternatively, the list of predefined issues or faults may be stored in a remotely located database accessible to the monitor system 102. The monitor system 102 may be configured to communicate with the remotely located database in order to access the list of predefined faults.

Each known issue included within the list of predefined faults may correspond to a criticality rating and/or may include, for example, a self-maintenance indicator to indicate that the issue or fault is serviceable, by the home owner or customer without the direct involvement of a contractor. For example, the criticality rating may indicate whether a known issue is a non-critical issue. The monitor system 102 determines whether the issue is a non-critical issue based on the criticality rating correlating to a corresponding known issue within the list of predefined issues. For example, the monitor system 102 may determine that the issue is a faulty or dirty furnace filter within the HVAC system 16. The monitor system 102 may then determine that a faulty or dirty furnace filter is a non-critical issue based on the issue criticality rating correlating to a faulty furnace filter issue. Additionally or alternatively, the list or predefined issues may include a self-maintenance indicator for each of the issues corresponding to whether the issue has been designated as appropriate for self-maintenance service by the home owner or customer without involvement of a contractor. In other words, the self-maintenance indicator may indicate that certain predetermined issues or repairs have been designated as issues or repairs that can be addressed or performed by a home owner, customer, or other individual, for example, without involvement or assistance of a professional contractor or other trained repair person. The self-maintenance option may not be available, for example, for repairs or component replacements that require specialized tools or the technical knowledge, training, or certification of a professional contractor. As an example, a faulty or dirty furnace filter may be an issue designated for self-maintenance. In other words, the home owner or customer can address the issue by replacement of the furnace filter. As another example, the replacement of an electronic component of the furnace may be an issue that is not designated for self-maintenance and may require the involvement of a professional contractor.

When the monitor system 102 determines that the issue is a non-critical issue designated for self-maintenance, the monitor system 102 may generate an alert corresponding to the issue. The monitor system 102 may communicate the alert to the customer device 12 and/or to the contractor locator/dispatch system 10. The customer device 12 may generate a customer interface display for the non-critical issue based on the alert. For example, the customer interface may provide options for the customer to purchase a replacement component needed to address the issue.

With reference to FIG. 21A, a customer interface display for a non-critical issue is shown and may include a fault detection message box 50. The fault detection message box 50 is arranged to display a fault detection message. For example, the customer device 12 may generate a fault detection message based on the alert. The customer device 12 displays the message based on the alert within the fault detection message box 50. The fault detection message may include a name, part number, or component description sufficient to identify, for example, a faulty component associated with the alert.

In some implementations the customer interface display for the non-critical issue includes an efficiency status message box 54, as shown in FIG. 21B. The efficiency status message box 54 is arranged to display an efficiency message associated with the HVAC system 16. For example, the list of predefined issues may also include an efficiency status correlating to a known issue. The efficiency status may be a text string indicating whether the HVAC system 16 is operating efficiently. The customer device 12 is configured to communicate with the database that stores the list of predefined issues, either directly or indirectly through the monitor system 102, to receive the corresponding efficiency status information.

The monitor system 102 and/or the customer device 12 may compare the issue corresponding to the alert with the list of predefined issues. The monitor system 102 and/or the customer device 12 may determine a current efficiency status of the HVAC system 16 based on the efficiency status correlating to the issue. For example, the issue may be that the furnace filter within the HVAC system 16 is faulty. The efficiency status correlating to a faulty furnace filter may indicate that the HVAC system 16 is not operating efficiently. The customer device 12 may then display a message within the efficiency status message box 54 indicating that the HVAC system 16 is not operating efficiently.

In some implementations, for non-critical issues that have been designated as appropriate for self-maintenance for example, the customer device 12 may display an interface 57 that includes an option for the user to select to have a contractor to deliver a replacement component or to select to purchase the replacement component through a commercial retailer. In this way, a user associated with the customer device 12 may select whether to have a contractor deliver a replacement component or to purchase a replacement component from a commercial retailer. For example, the interface 57 may include a contractor delivery option message box 56 and a customer purchase option message box 58. The contractor delivery option message box 56 is arranged to allow the user of the customer device 12 to select to have a contractor deliver a component to replace the faulty component displayed in the fault detection message box 50. For example, as described above, the customer device 12 may communicate with the contractor locator/dispatch server 40 (shown in FIG. 4) of the contractor locator/dispatch system 10. The customer device 12 may communicate a part name, number, or description associated with the faulty component to the contractor locator/dispatch server 40. The contractor locator/dispatch server 40 may determine whether a contractor from the contractor database 46 has a replacement for the faulty component in stock based on the part name, number, or description. When a contractor from the contractor database 46 has a replacement component, the contractor locator/dispatch server 40 may communicate information for the identified contractor with the replacement component to the customer device 12.

In some implementations, the contractor locator/dispatch server 40 may also determine whether the replacement component has an alternative replacement component. For example, the contract locator/dispatch server 40 is arranged to communicate with a predefined list of replacement components. The predefined list of replacement components may be a look-up table stored within an associated memory of the contractor locator/dispatch server 40. Alternatively, the predefined list of replacement components may be stored in a replacement component database. The predefined list of replacement components is a list of replacement components associated with the HVAC system 16. Each replacement component within the list of replacement components may correlate to a component price, an associated replacement alternative, and a replacement alternative price.

The associated replacement alternative may indicate, for example, that a high efficiency replacement component may be used as an alternative to a normal replacement component. For example, the list of replacement components may include a furnace filter. The normal furnace filter may have an associated alternative replacement furnace filter. The alternative replacement furnace filter may be a high efficiency replacement furnace filter. The contractor locator/dispatch server 40 communicates the replacement component price, the associated alternative replacement component, and the alternative replacement price to the customer device 12.

When a customer opts for a contractor to deliver a replacement component, the customer device 12 generates a contractor select message based on the identified contractor with the suitable replacement component. For example, the contractor select message includes the name and contact information associated with the contractor. The customer device 12 displays the contractor select message within the contractor delivery option message box 56. The customer device 12 also generates a part selection message based on the replacement component price, the alternative replacement component, and the replacement component price.

For example, the customer device 12 displays a replacement component price and an alternative replacement component price within the contractor delivery option message box 56. The customer device 12 also generates a select button corresponding to the replacement component price and a select button corresponding to the alternative replacement component price. The user of the customer device 12 may then select to have the contractor deliver a replacement component to the user by selecting either the replacement component price or the alternative replacement component price.

Alternatively, the user may opt to order a replacement component from a commercial retailer. For example, the customer device 12 is arranged to generate a commercial retailer message within the customer purchase option message box 58. The commercial retailer message may indicate to the user that the user may purchase a replacement component without contacting a contractor by selecting a continue button included within the customer purchase option message box 58. When the user selects the continue button, the customer device 12 may communicate with multiple commercial retail websites. For example only, the multiple commercial retail websites may include the website for AMAZON.COM™. Each of the commercial retail websites may include a search engine. The customer device 12 may search for the part number associated with the faulty component within each of the search engines for the multiple commercial retail websites.

The customer device 12 determines whether a commercial retail website currently stocks the replacement component based on whether the part number was found at the commercial website. The customer device 12 may generate a list of commercial websites that currently stock the replacement part. The customer device 12 may then display a list of the commercial retail websites that currently stock the replacement part within the customer device 12. The user may then purchase the replacement component from one of the commercial retail websites in the list of commercial retail websites.

After the user has either arranged for the contractor to deliver the replacement component or purchased the replacement component from a commercial retail website, the customer device 12 generates a confirmation message as shown in FIG. 21C. The confirmation message includes a confirmation message box 60. The confirmation message box 60 indicates to the user that the replacement component was successfully ordered. The confirmation message box 60 may also include further instructions or suggestions with respect to the replacement component. For example, the confirmation message box 60 may generate a message including a multimedia attachment 62. The multimedia attachment 62 may be an instructional video, for example, on how to install the replacement component. For example, the multimedia attachment 62 may include a video that demonstrates how to install a replacement filter. It is understood that the multimedia attachment 62 may be a video, an audio file, a graphical presentation such as a series of instructional photographs or figures, or any other suitable media for communicating instructions or other information to the user.

With reference to FIG. 22A, an alternative customer interface is shown. In some implementations, the customer device 12 may generate the alternative customer interface when, for example, the monitor system 102 determines that the issue is a critical issue that is not normally serviceable by the home owner or customer without involvement or assistance of a professional contractor to make a repair or replace a system component. In such case, the customer device 12 may prompt the user or customer to schedule an appointment with a contractor to address the issue. For example, the customer device 12 may determine the criticality of the issue based on an associated operating status. The customer device 12 is configured to communicate with the database storing the list of predefined issues. The customer device 12 may compare the issue corresponding to the current alert with the list of predefined issues. The customer device 12 may determine a current operating status of the HVAC system 16 based on the operating status that correlates to the issue. For example, the issue may be that a capacitor within the HVAC system 16 is faulty. The operating status correlating to a faulty capacitor may indicate that the HVAC system 16 is not operating. When the customer device 12 determines the HVAC system 16 is not operating, the customer device 12 may generate the alternative customer interface.

The alternative customer interface may include the fault detection message box 50 and a calendar interface 64 for scheduling an appointment for a contractor to perform maintenance on the HVAC system. Additionally or alternatively, the alternative customer interface may include the operating status message box 54 as shown in FIG. 22B. The calendar interface 64 is arranged to display blocks of time corresponding to an availability of the contractor and an availability of the user. As discussed above, the customer device 12 may include a calendar application. The user of the customer device 12 may update the calendar application to reflect the user's availability. For example, the user may create a calendar entry indicating the user is not available during a specific period. The customer device 12 is also arranged to communicate with a contractor calendar application.

For example, the customer device 12 may interface, through the contractor locator/dispatch system 10, with a calendar application of the contractor device 14 to determine availability of the particular contractor. For example, the contractor may create a calendar entry in the calendar application of the contractor device 14 indicating the contractor is not available for a specific period. The customer device 12 may communicate with the contractor locator/dispatch server 40. The contractor locator/dispatch server 40 may communicate with the contractor portal 42 (shown in FIG. 4) in order to continually determine and update the availability information for the contractor. The contractor locator/dispatch server 40 communicates the availability information of the contractor to the customer device 12.

The customer device 12 then generates the calendar interface 64 based on the availability information of the contractor and the calendar application within the customer device 12. In this way, the calendar interface 64 displays a calendar including specific periods of availability of the contractor and the user. The user may then select one of the specific periods of availability. When the user selects one of the specific periods of availability, the customer device 12 generates a message indicative of the specific period of availability selected by the user. The customer device 12 then communicates the message to the contractor device 14 through the contractor locator/dispatch system 10 to notify the contractor of the service appointment and to appropriately update the calendar application of the contractor device 14. The calendar application within the contractor device 14 may then indicate that the contractor is no longer available during the specific period selected by the user.

The customer device 12 may then generate a confirmation message based on the specific period selected by the user. For example, the customer device 12 may display a message indicating to the user that an appointment for service is scheduled at the specific period selected by the user. A similar message may be generated and displayed for the contractor with the contractor device 14.

With reference to FIG. 23, a control algorithm 400 for displaying a customer interface and coordinating contractor scheduling and replacement component purchasing starts at 404. At 408, the algorithm 400 receives a fault notification. At 412, the algorithm 400 determines whether the HVAC system is running. When the algorithm 400 determines that the HVAC system is running, the algorithm 400 continues at 416. When the algorithm 400 determines that the HVAC system is not running, the algorithm 400 continues at 444. At 416, the algorithm 400 determines whether a self-maintenance option is available for the particular issue or fault associated with the fault notification. When the algorithm 400 determines that the self-maintenance option is available, the algorithm 400 continues at 420. For example, the self-maintenance option may be available for repairs or component replacements that can be performed by a customer or home owner, for example, without special training, certification, or tools. In other words, the self-maintenance option may be available for repairs that a home owner can perform without involvement or assistance of a professional contractor or other trained repair person. The self-maintenance option may not be available for repairs or component replacements that require specialized tools or the technical knowledge, training, or certification of a professional contractor. When the algorithm 400 determines that the self-maintenance option is not available, the algorithm 400 continues at 452.

At 420, the algorithm 400 generates a low efficiency message, if applicable. At 424, the algorithm 400 generates a faulty component message. At 428, the algorithm 400 receives a user input indicative of whether the user selected to have a contractor deliver a replacement component. At 432, the algorithm 400 determines whether the user selected to have the contractor deliver the replacement component. If true, the algorithm 400 continues at 436. If false, the algorithm 400 continues at 440. At 436, the algorithm 400 generates a list of commercial retailers. At 440, the algorithm 400 generates a confirmation and displays installation instructions, such as a video or instructional sequence of figures.

At 444, the algorithm 400 generates a message indicating that the HVAC system is not currently running. At 448, the algorithm 400 generates a faulty component message. At 452, the algorithm 400 generates an appointment calendar. At 456, the algorithm 400 receives user input indicative of a selected appointment time. At 460, the algorithm 400 generates a confirmation based on the user input. The algorithm 400 ends at 464.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory. Non-limiting examples of a non-transitory tangible computer readable medium include nonvolatile memory, volatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

What is claimed is:

1. A system comprising:
a database storing a plurality of faults, each fault having an indicator corresponding to whether the associated fault is designated for self-maintenance;
a monitoring system in communication with the database and configured to monitor operating parameters of an HVAC system at a customer location, to detect or predict a fault in the HVAC system based on the monitored operating parameters, to determine whether the fault is designated for self-maintenance based on the database, and to communicate an alert corresponding to the fault to a customer device associated with the HVAC system;
wherein, when the alert received by the customer device indicates that the fault in the HVAC system is designated for self-maintenance, the customer device displays an identification of at least one replacement component associated with maintenance for the fault and a first interface to receive at least one of a first selection for a contractor to deliver the at least one replacement component and a second selection for purchasing the at least one replacement component through a commercial retailer.

2. The system of claim 1 wherein the at least one replacement component includes a normal efficiency component and a higher efficiency component and wherein the first selection includes an indication for the contractor to deliver the normal efficiency component or the higher efficiency component.

3. The system of claim 1 wherein the database includes instructional information associated with maintenance for the fault and wherein, when the alert received by the customer device indicates that the fault in the HVAC system is designated for self-maintenance, the customer device displays the instructional information associated with maintenance for the fault.

4. The system of claim 3 wherein the instructional information includes instructional information related to installation of the at least one replacement component.

5. The system of claim 3 wherein the instruction information includes at least one of video and audio information related to installation of the at least one replacement component.

6. The system of claim 1 wherein, when the alert received by the customer device indicates that the fault in the HVAC system is not designated for self-maintenance, the customer device displays a second interface to receive a third selection for scheduling an appointment for a contractor to perform maintenance on the HVAC system.

7. The system of claim 6 wherein the scheduling is based on communication with a first calendar application associated with the customer device and with a second calendar application associated with a contractor device associated with the contractor.

8. The system of claim 7 wherein, when the appointment is scheduled, the contractor device is notified of the scheduled appointment and the first and second calendar applications are updated to include the scheduled appointment.

9. The system of claim 1 wherein, when the customer device receives the second selection for purchasing the at least one replacement component through the commercial retailer, the customer device displays at least one commercial retail website with the at least one replacement component available for purchase.

10. A method comprising:
monitoring, with a monitoring system, operating parameters of an HVAC system at a customer location, the monitoring system being in communication with a database storing a plurality of faults, each fault having an indicator corresponding to whether the associated fault is designated for self-maintenance;
detecting or predicting, with the monitoring system, a fault in the HVAC system based on the monitored operating parameters;
determining, with the monitoring system, whether the fault is designated for self-maintenance based on the database;
communicating, with the monitoring system, an alert corresponding to the fault to a customer device associated with the HVAC system;
displaying, when the alert received by the customer device indicates that the fault in the HVAC system is designated for self-maintenance and with the customer device, an identification of at least one replacement component associated with maintenance for the fault and a first interface to receive at least one of a first selection for a contractor to deliver the at least one replacement component and a second selection for purchasing the at least one replacement component through a commercial retailer.

11. The method of claim 10 wherein the at least one replacement component includes a normal efficiency component and a higher efficiency component and wherein the first selection includes an indication for the contractor to deliver the normal efficiency component or the higher efficiency component.

12. The method of claim 10 wherein the database includes instructional information associated with maintenance for the fault, the method further comprising displaying, with the customer device, the instructional information associated with maintenance for the fault when the alert received by the customer device indicates that the fault in the HVAC system is designated for self-maintenance.

13. The method of claim 12 wherein the instructional information includes instructional information related to installation of the at least one replacement component.

14. The method of claim 12 wherein the instruction information includes at least one of video and audio information related to installation of the at least one replacement component.

15. The method of claim 10 further comprising:
displaying, with the customer device, a second interface to receive a third selection for scheduling an appointment for a contractor to perform maintenance on the HVAC system when the alert received by the customer device indicates that the fault in the HVAC system is not designated for self-maintenance.

16. The method of claim 15 wherein the scheduling is based on communication with a first calendar application associated with the customer device and with a second calendar application associated with a contractor device associated with the contractor.

17. The method of claim 16 wherein, when the appointment is scheduled, the contractor device is notified of the scheduled appointment and the first and second calendar applications are updated to include the scheduled appointment.

18. The method of claim 10 further comprising:
displaying, with the customer device, at least one commercial retail website with the at least one replacement component available for purchase when the customer device receives the second selection for purchasing the at least one replacement component through the commercial retailer.

19. A computer readable storage medium storing instructions executable by a processor for:
monitoring, with a monitoring system, operating parameters of an HVAC system at a customer location, the monitoring system being in communication with a database storing a plurality of faults, each fault having an indicator corresponding to whether the associated fault is designated for self-maintenance;
detecting or predicting, with the monitoring system, a fault in the HVAC system based on the monitored operating parameters;
determining, with the monitoring system, whether the fault is designated for self-maintenance based on the database;
communicating, with the monitoring system, an alert corresponding to the fault to a customer device associated with the HVAC system;
displaying, when the alert received by the customer device indicates that the fault in the HVAC system is designated for self-maintenance and with the customer device, an identification of at least one replacement component associated with maintenance for the fault and a first interface to receive at least one of a first selection for a contractor to deliver the at least one replacement component and a second selection for purchasing the at least one replacement component through a commercial retailer.

20. The computer readable medium recited by claim 19 wherein the at least one replacement component includes a normal efficiency component and a higher efficiency component and wherein the first selection includes an indication for the contractor to deliver the normal efficiency component or the higher efficiency component.

21. The computer readable medium recited by claim 19 wherein the database includes instructional information associated with maintenance for the fault, the computer readable medium further comprising instructions executable by the processor for displaying, with the customer device, the instructional information associated with maintenance for the fault when the alert received by the customer device indicates that the fault in the HVAC system is designated for self-maintenance.

22. The computer readable medium recited by claim 21 wherein the instructional information includes instructional information related to installation of the at least one replacement component.

23. The computer readable medium recited by claim 21 wherein the instruction information includes at least one of video and audio information related to installation of the at least one replacement component.

24. The computer readable medium recited by claim 19 further comprising instructions executable by the processor for:
displaying, with the customer device, a second interface to receive a third selection for scheduling an appointment for a contractor to perform maintenance on the HVAC system when the alert received by the customer device indicates that the fault in the HVAC system is not designated for self-maintenance.

25. The computer readable medium recited by claim 24 wherein the scheduling is based on communication with a first calendar application associated with the customer device and with a second calendar application associated with a contractor device associated with the contractor.

26. The computer readable medium recited by claim 25 wherein, when the appointment is scheduled, the contractor device is notified of the scheduled appointment and the first and second calendar applications are updated to include the scheduled appointment.

27. The computer readable medium recited by claim 19 further comprising instructions executable by the processor for:
displaying, with the customer device, at least one commercial retail website with the at least one replacement component available for purchase when the customer device receives the second selection for purchasing the at least one replacement component through the commercial retailer.
